(19) United States
(12) Patent Application Publication
(10) Pub. No.: US 2008/0185456 A1
(43) Pub. Date: Aug. 7, 2008

(54) Shower Apparatus

(76) Inventor: Stephen Charles McCabe, Victoria (AU)

Correspondence Address: ANNA WU, P.O. BOX 93286, CITY OF INDUSTRY, CA, 91715, US

(21) Appl. No.: 11/597,450

(22) PCT Filed: May 21, 2004
(86) PCT No.: PCT/AU04/00690

§ 371 Date: Nov. 21, 2006

(30) Foreign Application Priority Data
May 21, 2003 (AU) 2003902443

(51) Int. Cl. B05B 15/06; B05B 1/18; A47K 3/28

(52) U.S. Cl. 239/197; 239/562; 4/615

(57) ABSTRACT

A shower apparatus (10) for use in the bathing of humans comprises: a housing (12) for mounting on a wall (8) over or adjacent a water supply point, a spray head (2, 4, 6) connected to the water supply point (24) by a hose, valve means for controlling the amount of water flowing to the spray head, mounting means (3, 5) for retaining the spray head on or in the housing, means for extending the hose (14, 15) from the housing when the spray head is manually removed from the mounting means, and means for stowing (28) the hose into the housing when the spray head is retained by the mounting means.

### FIELD OF THE INVENTION

This invention concerns shower apparatus for human bathing. The assemblies are particularly adapted for fitment in shower enclosures or elsewhere in bathrooms and the like but may be used elsewhere.

### BACKGROUND TO THE INVENTION

Shower assemblies are well known and widely used and many configurations have been put to use. One particularly favorable shower assembly is described in U.S. Pat. No. 5,230,472 by McCabe.

Many designs of shower assemblies incorporate a flexible hose of some type one end of which is attached to a water supply point on the wall and the other end of which terminates at a water spray head from which the water is projected in multiple streams Commonly the spray head may be held by hand with the water directed accurately to the required parts of the user's body, or may be clipped or hung on a bracket whereupon the water issues in a more generally directed stream.

But such-assemblies leave the hose dangling in a downwards loop which is untidy, can get in the way of other activities in the shower and has the potential to damage other fitments by knocking them or pulling them down during movement of the user.

An aim of the present invention is to provide a shower apparatus which overcomes or at least reduces these difficulties.

There have been various proposals to provide hand-held showers having hose rewinding mechanisms which are built into the walls of the shower. Examples are shown in patent specifications DE 201 13 857 U (Halbwirth), US 200210042950 A1

When the spray head is retained by the mounting means, the connection between the spray head and the mounting means may permit the direction of water issuing from the spray head to be adjusted by the user.

Alternatively the retraction means may comprise a reel onto which the hose winds as it retracts into the housing. The reel may be spring loaded and may have a latch mechanism whereby the tension imparted by the spring may be isolated from the end of the hose adjacent the spray head

The apparatus may comprise two such spray heads on respective hoses each spray head having a separate said mounting means and retraction means. Said retraction means may comprise two reels which may be mounted with their axes of rotation co-linear or approximately co-linear. The axes may be generally horizontal and parallel to the wall.

In another aspect the invention provides a shower apparatus for use in the bathing of humans, said apparatus comprising:
a housing adapted to be mounted on a wall over or adjacent a water supply point,
two spray heads connected by water connection means to said water supply point, said water connection means including a separate hose for each of said two spray heads,
valve means for controlling the amount of water flowing from the water supply point to the spray heads,
mounting means for retaining the spray heads on or in the housing whereupon water issuing from the spray heads may be directed away from the wall,
retraction means for retracting the hoses into the housing when the spray heads are being retained by the mounting means, and
extension means for extending the hoses independently from the housing when the spray heads are manually removed from the mounting means. (Nasr et al) and DE 44 40 995 A1 (Junginger). However all of these suffer the disadvantage that water, soap scum, general dirt and grit are carried by the hose, as it is recoiled into the wall cavity where it can fall off the hose. The above mentioned Halbwirth and Nasr patent specifications describe various housings and containers constructed into the walls to catch and dram away such water but, in practice, much soap scum, body oils and general grime would deposit and stay in the container leading to potential growth of organisms and production of smells, as well as providing a moist atmosphere which hastens rot of the general wall structure.

Publication DE 39 01 007 A1 (Hans Grohe GmbH) describes a hose recoiling mechanism, but this is primarily for the collection of waste water rather than for showering purposes.

### SUMMARY OF THE INVENTION

Accordingly, in one aspect the invention provides a shower apparatus for use in the bathing of humans, said apparatus comprising:
a housing adapted to be mounted on the exposed face of a wall over or adjacent a water supply point,
a spray head connected by water connection means to said water supply point, said water connection means including a hose,
valve means for controlling the amount of water flowing from the water supply point to the spray head,
mounting means for retaining the spray head on or in the housing whereupon water issuing from the spray head may be directed away from the wall,
retraction means for retracting the hose into the housing when the spray head is retained by the mounting means, and
extension means for extending the hose from the housing when the spray head is manually removed from the mounting means.

The apparatus may also include a spray head which is fixed to the housing without a hose that may be withdrawn, and the fixed spray head may not be adjustable other than by the amount of water flow. A said fixed spray head may be flanked by a pair of mounting means for spray heads on hoses which may be extendible from the housing.

The spray head or heads may be fed from a single water supply point on the wall to which water of a predetermined temperature is directed. Alternatively the spray head or heads may be fed from both a hot water supply point and a cold water supply point on the wall and the ratio of hot to cold is controlled by temperature control means on the housing. The temperature control means may comprise a pair of valves, one each for hot and cold water, or may comprise a single mixer valve. The temperature control means may comprise means for automatically issuing water at a set temperature or may comprise manually controlled valves for hot and cold water.

The mounting means may provide for the direction of water flow from the spray heads to be adjusted.

In another aspect the invention provides a shower apparatus for use in the bathing of humans, said apparatus comprising:
a housing adapted to be mounted on a wall over or adjacent a water supply point,
a spray head connected by water connection means to said water supply point, said water connection means including a hose,
valve means for controlling the amount of water flowing from the water supply point to the spray head,
mounting means for retaining the spray head on or in the housing whereupon water issuing from the spray head may be directed away from the wall,
means for extending the hose from the housing when the spray head is manually removed from the mounting means, and
means for stowing the hose into the housing when the spray head is retained by the mounting means.

The housing may include a saddle shaped portion onto which the hose may be stowed. The saddle shaped portion may be elongated The hose may be wound around a reel adjacent the saddle.

The apparatus may comprise two such spray heads on respective hoses each spray head having a separate said mounting means and stowing means.

The housing may include dispenser or dispensers for consumable items such as liquid soap, shampoo, hair conditioner, shaving cream and deodorant.

### BRIEF DESCRIPTION OF THE DRAWINGS

In order that the invention may be more fully understood there will now be described, by way of example only, preferred embodiments and other elements of the invention with reference to the accompanying drawings where:

FIG. 1A is a close up, partial see-through, elevation view of a shower apparatus according to a first embodiment of the invention,

FIG. 1B is a perspective view of the apparatus in FIG. 1A,

FIG. 1C is a general view showing the apparatus in FIG. 1A in use,

FIG. 2A is a close up elevation view of a shower apparatus according to a second embodiment of the invention,

FIG. 2B is a perspective view of the apparatus in FIG. 2A,

FIG. 2C is a general view showing the apparatus in FIG. 2A in use,

FIG. 3A is a close up elevation view of a shower apparatus according to a third embodiment of the invention,

FIG. 3B is a perspective view of the apparatus in FIG. 3A,

FIG. 3C is a general view showing the apparatus in FIG. 3A in use,

FIG. 4A is a close up elevation view of a shower apparatus according to a fourth embodiment of the invention,

FIG. 4B is a perspective view of the apparatus in FIG. 4A, and

FIG. 4C is a general view showing the apparatus in FIG. 4A in use.

### DESCRIPTION OF THE PREFERRED EMBODIMENT AND OTHER EXAMPLES OF THE INVENTION

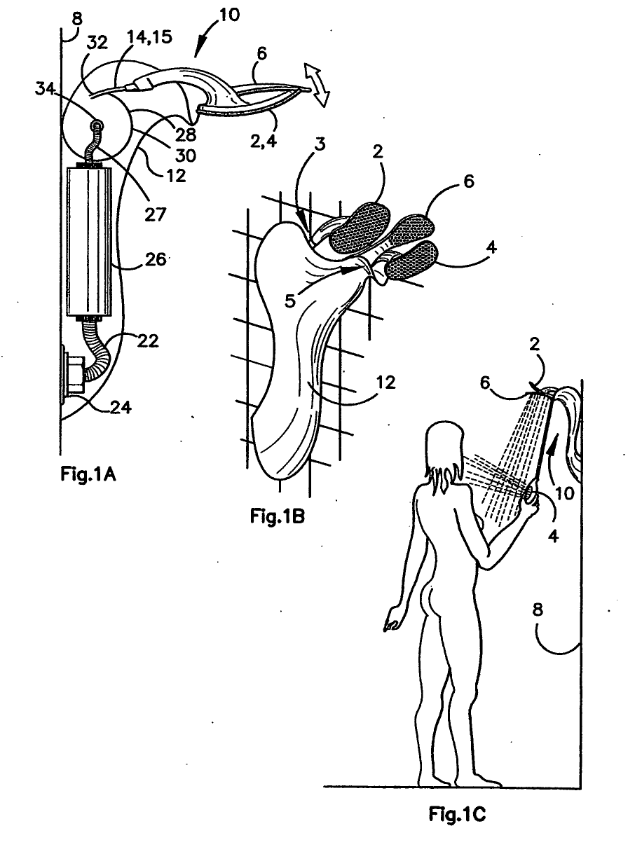

Referring to FIGS. 1A, 1B and 1C, the housing 12 of a shower assembly 10 is mounted to a wall 8 such that it covers and thus conceals the single water supply point supplying the assembly. The assembly 10 has three spray heads 2, 4 and 6. Spray heads 2 and 4 are fitted to respective mounting recesses 3 and 5 respectively and are removable from those recesses by a user or users who may then use them as hand-held shower sprays. When removed, each head 2 and 4 is connected by a hose 14 and 15 respectively to the housing 12. The hoses automatically play out from and retract back into the housing as the spray heads are moved away from and towards the housing. When they retract back into the housing the hoses 14 and 15 he hoses wind onto spring loaded reels which are described further hereunder.

A single hose 22 extends from a water supply point 24 in the wall 8 into the bottom of a water filter 26 mounted within the housing 12. The filter has an outer casing containing a replaceable filter element and is chosen to remove particulate matter from the water supply. The water exiting the filter is carried by a short length of hose 27 to connect to the centre of a reel assembly 28.

The reel assembly 28 comprises a pair of co-axially mounted reels 30 with each reel being independently rotatable and having a length of rubber hose 32 wound thereon. Water passes from the hose 27 to a water supply conduit 34 extending along the axis of rotation of the reels. Bach hose 32 is fitted to its respective reel 30 such that the innermost end of the hose 32 is connected in a water flow sense to the conduit 34. The outermost end of each hose 32 is fastened to the inlet of a corresponding spray head 2 and 4.

The reels are spring loaded to provide a recoil force when the hose thereon is extended. Each reel may carry a latch mechanism whereby the recoil force is nullified at will by the user.

Spray heads 2 and 4 have a generally paddle shape with a generally oval face and are generally symmetrical about orthogonal axes although they have a slight convex curve in the direction outwardly from the wall when fitted into the recesses 3 and 5.

Although the spray head 6 cannot be used as a hand held spray head, its tilt is adjustable as indicated by the arrows in FIG. 1A. Spray heads 2 and 4 rest more or less in the same position when they are returned to their recess 3 and 5.

In FIG. 1C the person illustrated is receiving spray from spray head 6 on the housing and from the spray head 4 being held by hand?

The main body of the housing is moulded from plastics material. It conceals the reels, filter and water supply point on the wall.

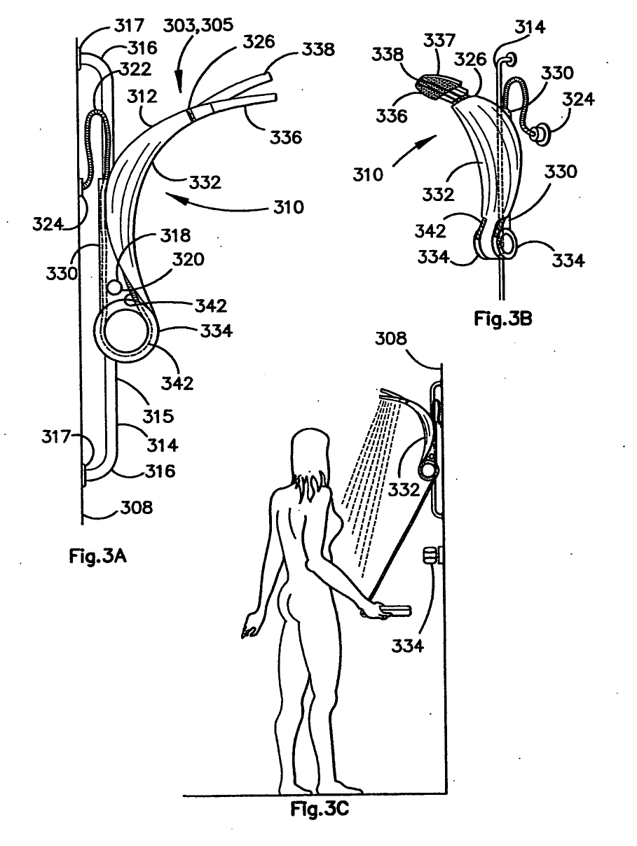

Referring to FIGS. 3A, 3B and 3C, the housing 312 of a shower assembly 310 is mounted to a wall 308 by way of tubing 314 upon which the housing slides up and down. The tubing 314 has a straight vertical central portion 315 and right angle bends 316 at each end which extend to the wall 308 where the tube is affixed to the wall. The housing 312 may be clamped at the desired vertical position on the tubing 314 by means of a clamp 318 activated by rotating a knob 320 extending from a side of the housing 312.

The housing 312 is moulded from a suitable plastics material. It has a tubular support portion 330 through which the central portion 315 of the tubing passes. Integrally moulded with the tubular support portion is an approximately side shaped portion 332 the front surface of which is the largest visible part of the assembly. At the bottom a pair of pulley shaped guides 334 are formed below the saddle shaped portion 332.

The saddle shaped portion 332 serves to aesthetically conceal the water supply point 324, the tubular support portion 330 and the slack portion of hose 322 which is there to allow the assembly to move to the extremes of the tubing 314.

A single hose 322 extends from a water supply point 324 at the wall 8 into the top of the tubular support portion 330. A flow splitter (not shown) within the tubular support portion 330 divides the water flow into two, and the two consequent hoses 342 pass around respective guides 334 from the rear to emerge at the front of the assembly. The guides 334 carry peripheral cover strips on their lower portion which serves to retain the hoses 342 on the guide when a spray head 336 or 337 is being used.

The downstream end of each hose 342 is fastened to the inlet of a corresponding spray head 336, 337. Spray head 336 is non symmetrical and is a mirror image of spray head 337.

As a spray head 336 or 337 is being stowed in its mounting recess, a simple movement of the hose 342 positions it around behind the saddle shaped portion 332 as shown in FIGS. 3A and 3B. Valves (taps) 344 are shown on the wall 308 in FIG. 3C.

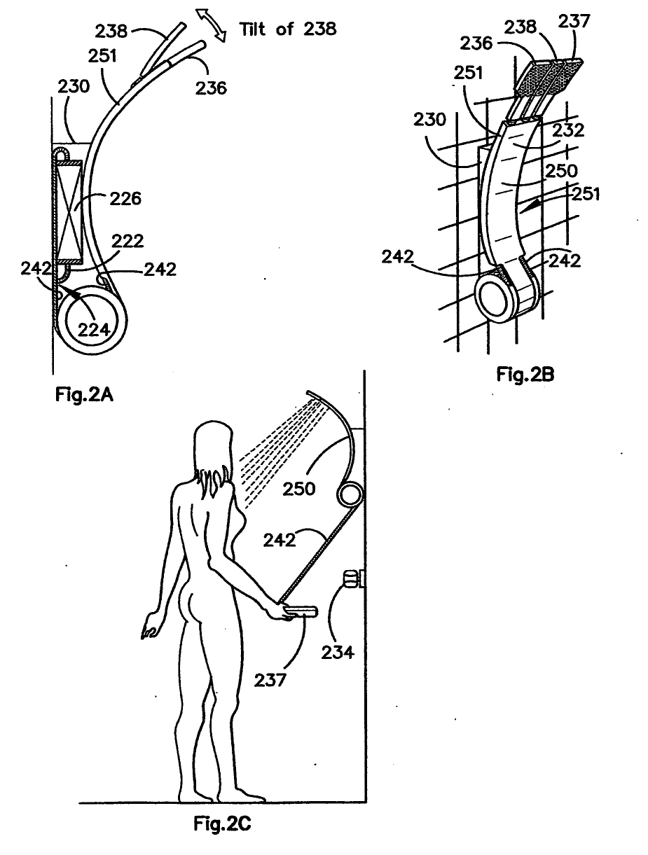

Referring now to FIGS. 2A, 2B and 2C, the configuration is a different combination of features described in relation to FIGS. 1 and 3 together with some additional variations. Like the embodiment in FIG. 3B, the two hoses feeding the hand-held spray heads 236 and 237 are tucked in behind the main body portion 232. But the main body portion 232 is channel shaped with a main face 250 being curved only in the vertical direction. A small flange 251 on each side edge forms a wall which restrains the hoses 242 from sliding forward

A tall rectangular box 230 formed behind the main body portion 232 conceals the water supply point 224 on the wall and also hides an optional filter unit 226 like that described above with reference to FIG. 1A.

The central spray head 238 is not hand held but it does tilt back and forth transverse to the wall in a vertical plane.

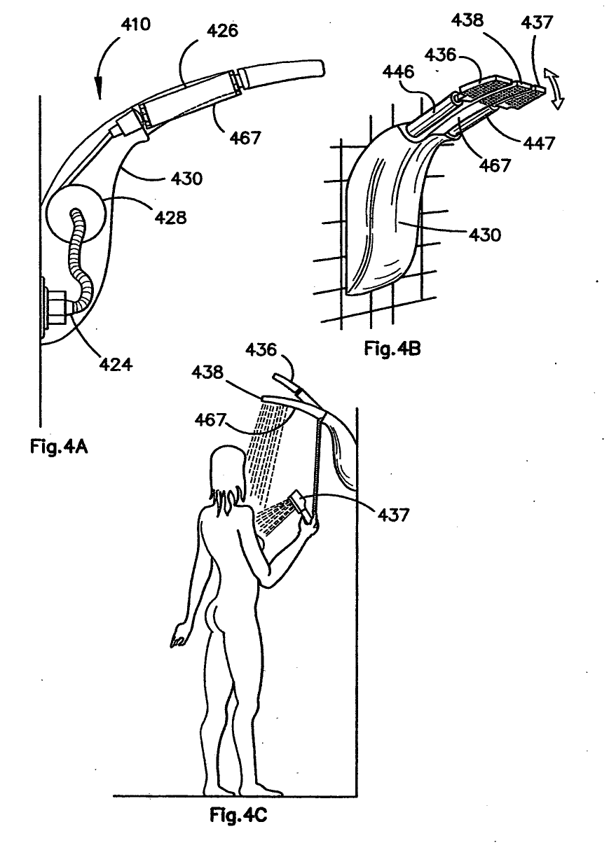

Referring to FIGS. 4A, 4B and 4C, the assembly 410 again has two hand held spray heads 436, 437 flanking a non hand held spray head 438. A main body portion 430 covers the water supply point 424 and houses a reel assembly 428 of the type described for FIG. 1A. But spray heads 436 and 437 have water filter elements 426 inserted into their individual handles 446 and 447, and spray head 438 has a filter element 426 in its corresponding arm 467 immediately upstream of the water exit area.

The shower apparatus provided by the present invention has the advantage that it may be readily fitted to the face of a wall in an existing shower facility with no modification to the walls other than the provision of appropriate fastenings to the wall It could be installed by tenants in rental accommodation with a view to taking it with them when they moved to new accommodation.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A shower apparatus for use in the bathing of humans, said apparatus comprising:
a housing adapted to be mounted on a wall over or adjacent a water supply point,
a spray head connected by water connection means to said water supply point, said water connection means including a hose,
valve means for controlling the amount of water flowing from the water supply point to the spray head,
mounting means for retaining the spray head on or in the housing whereupon water issuing from the spray head may be directed away from the wall,
retraction means for retracting the hose into the housing when the spray head is retained by the mounting means, and
extension means for extending the hose from the housing when the spray head is manually removed from the mounting means.

2. A shower apparatus according to claim 1 wherein the spray head is retained by the mounting means and the connection between the spray head and the mounting means permits the direction of water issuing from the spray head to be adjusted by the user.

3. A shower apparatus according to claim 1 wherein the retraction means comprises a reel onto which the hose winds as it retracts into the housing.

4. A shower apparatus according to claim 3 wherein the reel is spring loaded and has a latch mechanism whereby the tension imparted by the spring may be isolated from the end of the hose closest to the spray head.

5. A shower apparatus for use in the bathing of humans, said apparatus comprising:
a housing adapted to be mounted on a wall over or adjacent a water supply point,
two spray heads connected by water connection means to said water supply point, said water connection means including a separate hose for each of said two spray heads,
valve means for controlling the amount of water flowing from the water supply point to the spray heads,
mounting means for retaining the spray heads on or in the housing whereupon water issuing from the spray heads may be directed away from the wall,
retraction means for retracting the hoses into the housing when the spray heads are being retained by the mounting means, and
extension means for extending the hoses independently from the housing when the spray heads are manually removed from the mounting means.

6. A shower apparatus according to claim 5 wherein said retraction means comprises two reels which are mounted with their axes of rotation co-linear or approximately co-linear.

7. A shower apparatus according to claim 6 wherein said axes are horizontal and parallel to the wall.

8. A shower apparatus according to claim 5 wherein each of said two spray heads are fitted to respective hoses and each spray head has a separate said mounting means and retraction means.

9. A shower apparatus according to claim 8 wherein said two retraction means comprise a pair of reels which are mounted with their axes of rotation collinear or generally co-linear

10. A shower apparatus according to claim 9 wherein said axes of rotation are horizontal and parallel to the wall.

11. A shower apparatus according to any one of the previous claims wherein the apparatus includes an additional spray head which:
is fixed to the housing,
does not have a hose that may be withdrawn, and
is not adjustable other than by the amount of water flow through it.

12. A shower apparatus according to claim 11 wherein said fixed spray head is flanked by a pair of mounting means for spray heads on hoses which are extendible from the housing.

13. A shower apparatus for use in the bathing of humans, said apparatus comprising:
a housing adapted to be mounted on a wall over or adjacent a water supply point,
a spray head connected by water connection means to said water supply point, said water connection means including a hose,
valve means for controlling the amount of water flowing from the water supply point to the spray head,
mounting means for retaining the spray head on or in the housing whereupon water issuing from the spray head may be directed away from the wall,
means for extending the hose from the housing when the spray head is manually removed from the mounting means, and
means for stowing the hose into the housing when the spray head is retained by the mounting means.

14. A shower apparatus according to claim 13 wherein the housing includes a saddle-shaped portion onto which the hose may be stowed.

15. A shower apparatus according to claim 14 wherein the saddle shaped portion is elongated.

16. A shower apparatus for use in the bathing of humans, said apparatus comprising:
a housing adapted to be mounted on a wall over or adjacent a water supply point,
two spray heads connected by water connection means to said water supply point, said water connection means including a separate hose for each of said two spray heads,
valve means for controlling the amount of water flowing from the water supply point to the spray heads,
mounting means for retaining each spray head on or in the housing whereupon water issuing from the spray heads may be directed away from the wall,
means for extending each hose from the housing when the respective spray head is manually removed from its respective mounting means, and
means for stowing each hose into the housing when the respective spray head is retained by its respective mounting means.

17. A shower apparatus according to any one of claims 13 to 17 wherein the apparatus includes an additional spray head which:
is fixed to the housing,
does not have a hose that may be withdrawn, and
is not adjustable other than by the amount of water flow through it.

18. A shower apparatus according to claim 17 wherein said fixed spray head is flanked by a pair of mounting means for spray heads on hoses which are extendible from the housing.
